(19) United States
(12) Patent Application Publication
(10) Pub. No.: US 2026/0039234 A1
(43) Pub. Date: Feb. 5, 2026

(54) METHODS AND SYSTEMS FOR AN ELECTRIC MACHINE

(71) Applicant: Ford Global Technologies, LLC, Dearborn, MI (US)

(72) Inventors: Raphael Koch, Odenthal (DE); Goekhan Tasgin, Cologne (DE)

(21) Appl. No.: 19/277,251

(22) Filed: Jul. 22, 2025

(30) Foreign Application Priority Data
Aug. 5, 2024 (DE) 102024122277.8

(51) Int. Cl. H02P 29/62

(52) U.S. Cl. CPC H02P 29/62; H02P 2207/05

(57) ABSTRACT

Methods and systems are provided for an electric machine. In one example, a method may include activating an ultrasound emitter of the electric machine to provide ultrasound to a plate stack of a rotor of the electric machine. The method further includes applying ultrasound at different frequencies based on conditions of the electric machine.

### CROSS REFERENCE TO RELATED APPLICATION

The present application claims priority to German Patent Application No. 102024122277.8 filed on Aug. 5, 2024. The entire contents of the above-listed application is hereby incorporated by reference for all purposes.

### FIELD

The present description relates generally to applying ultrasound to an electrical machine.

### BACKGROUND/SUMMARY

Electrical machines may be classified as energy converters. A distinction is drawn between rotating electrical machines, which include various types of electric motors and electric generators, and stationary electrical machines, which include transformers. A further category of electrical machines is represented by linear motors, which may also be configured to be operable as generators. A common feature of all electrical machines is that their configuration incorporates a magnetic circuit for operation.

The magnetic circuit includes a magnetic flux, which, generated in operation, is deliberately directed into an iron core. This core includes materials which are capable of effectively conducting the magnetic flux. For example, the core may include materials that consist of laminated electric sheet steel plates which, in combination, form a plate stack. The laminated structure, in combination with a C5 lacquer insulation which is applied to one side or both sides of the sheet metal elements, is employed for the inhibition of unwanted eddy currents.

In operation, however, hysteresis losses occur, which losses may be manifested as a phase displacement between the magnetic flux and the electric current. These losses may be attributable to the work which it is necessary to apply for the magnetic reversal of the plate stack, in whole or in part, in the rhythm of a working frequency. Thus, there may be a demand to reduce the described hysteresis losses to increase the range of an electric operation of a vehicle.

In one example, the issues described above are at least partially solved by a method for operating an electrical machine, which method further includes applying an ultrasound to a plate stack of an electric machine during a first condition at a first frequency.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic exploded representation of an electric machine;

FIG. 2 shows a schematic cross-sectional representation of a stator of the electric machine of FIG. 1;

FIG. 3 shows a schematic representation of a comparison of two hysteresis curves;

FIG. 4 shows a schematic representation of further details of the operation of the electric machine of FIG. 1;

FIG. 5 shows a schematic representation of further details of the operation of the electric machine of FIG. 1;

FIG. 6 shows a schematic representation of a process sequence for the operation of the electric machine of FIG. 1; and

FIG. 7 shows a second representation of the electric machine.

### DETAILED DESCRIPTION

The following description relates to systems and methods for reducing hysteresis of an electric machine. The electrical machine can be a rotating electrical machine, such as an electric motor or an electric generator, or a stationary electric machine, such as e.g. a transformer. The electrical machine can also be configured as a linear motor, which can also be configured to be operable as a generator.

The application of ultrasound to the plate stack of an electrical machine may reduce hysteresis losses. Ultrasound in the kHz or MHz range may be used. The energy efficiency of the electrical machine can be enhanced accordingly.

According to one embodiment, a method for the electric machine may further include interrupting or reducing the ultrasound to the plate stack of the electrical machine.

It is thus not demanded, during the operation of the electrical machine, for ultrasound to be applied continuously to the plate stack of the electrical machine. Instead, an intermittent application of ultrasound to the plate stack is desired. Energy demand for the application of ultrasound to the plate stack may be reduced, such that the energy efficiency of the electrical machine may be further enhanced.

According to a further embodiment a method includes an at least intermittent application of ultrasound to the plate stack of the electrical machine in conjunction with maximum values and/or minimum values of a magnetic field strength within a working frequency of the electrical machine and interruption or reduction of the application of ultrasound to the plate stack of the electrical machine in conjunction with zero-crossings of the magnetic field at the working frequency of the electrical machine.

The working frequency is understood as the frequency of an electric voltage or of an electric current which is employed for operating the electrical machine, or which is delivered by the electrical machine. In the case e.g. of an asynchronous machine, the working frequency would be the frequency of the external rotating field which is generated via the stator. However, the working frequency may be dependent upon the number of poles of the electrical machine, and thus upon whether the electrical machine is configured e.g. with a two-pole or eight-pole design.

It is thus achieved that, during the first step, minimums and maximums in the hysteresis curve are eradicated, such that the major proportion of hysteresis losses may be counteracted. In one example, this applies in the region of the respective maximum or minimum values, as this region is associated with a directional switchover involving a stronger magnetic reversal whereas, in the region of zero-crossings through the x-axis (abscissa) of the hysteresis curve, only a limited magnetic reversal occurs. In another example, the magnetic reversal is larger at the zero-crossing through the x-axis relative to the minimum or maximum values due to a slope of the hysteresis curve being larger through the zero-crossings. The duration of the first step, in relation to the period of oscillation or to the total duration of both steps, can be 5%, 10%, 20%, 30%, 40%, 50%, or intermediate values thereof.

Energy demand for the application of ultrasound to the plate stack may thus be further reduced, and the energy efficiency of the electrical machine further enhanced accordingly.

According to a further embodiment, ultrasound is employed at a frequency which is a multiple of a working frequency of the electrical machine. It is thus achieved that, during one cycle, a multiplicity of ultrasound pulses is applied to the plate stack. Hysteresis losses may thus be reduced in an effective manner.

According to a further embodiment, the ultrasound frequency is a 100× to 600× multiple of the working frequency, in particular a 100× to 300× multiple of the working frequency of the electrical machine. Hysteresis losses can thus be reduced in a particularly effective manner.

According to a further embodiment, the plate stack is assigned to a stationary part of the electrical machine. In the event that, e.g. the electrical machine is configured as an electrical machine having a stator and a rotor, ultrasound is applied to the plate stack of the stator. In an analogous manner, in the case of a linear motor, ultrasound is applied to a plate stack of the stationary part of the linear motor. Consideration is thus given to the circumstance whereby hysteresis losses particularly occur in stationary parts of an electrical machine. In this manner, a particularly effective reduction of hysteresis losses can be achieved.

According to a further embodiment, by the at least intermittent application of ultrasound to the plate stack of the electrical machine, the plate stack undergoes heat-up. Efficiency can thus be further increased, as a high temperature in the plate stack reduces eddy current losses.

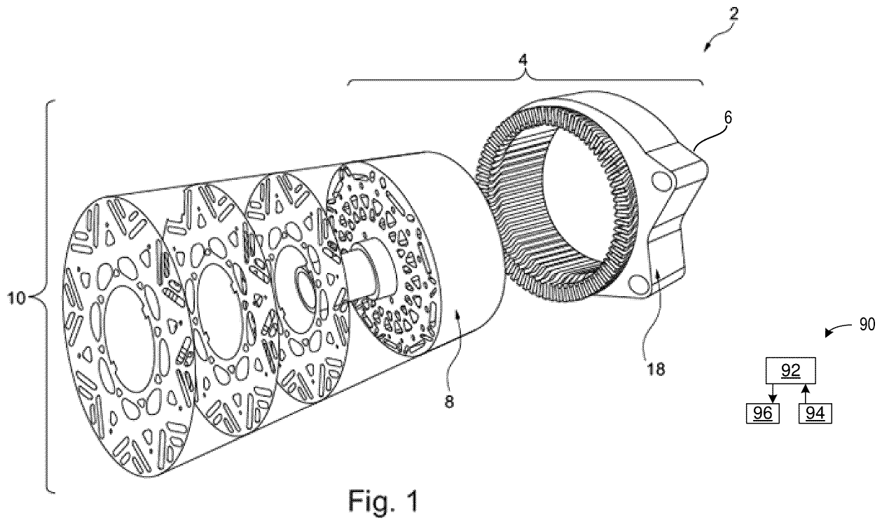

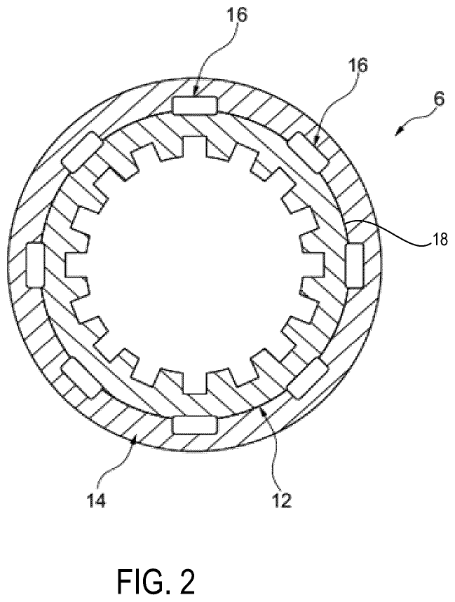

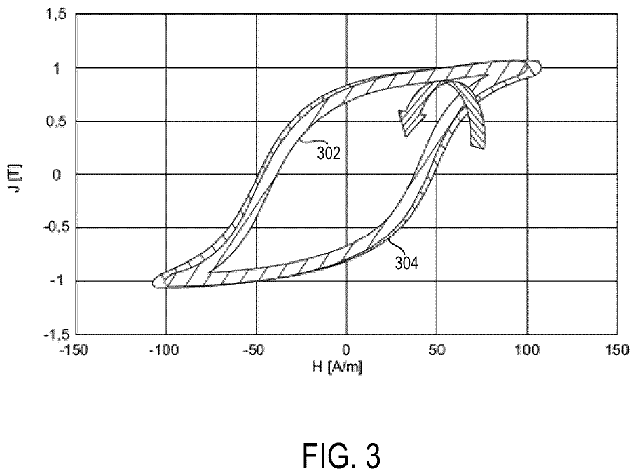

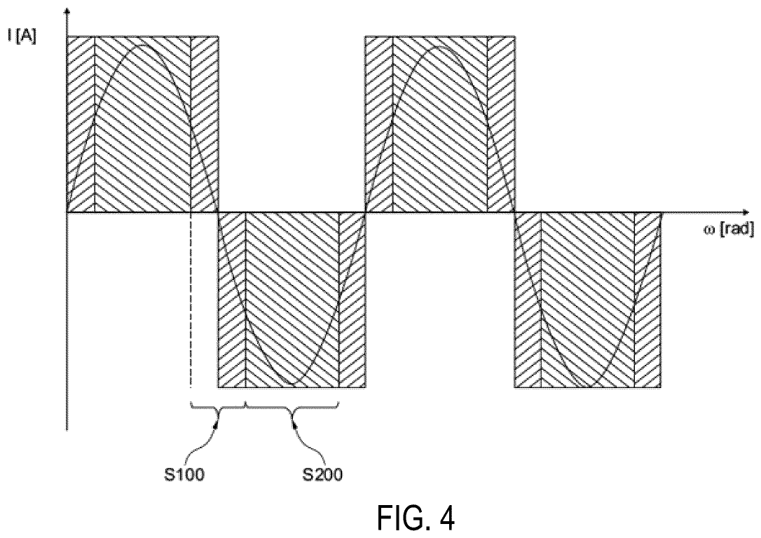

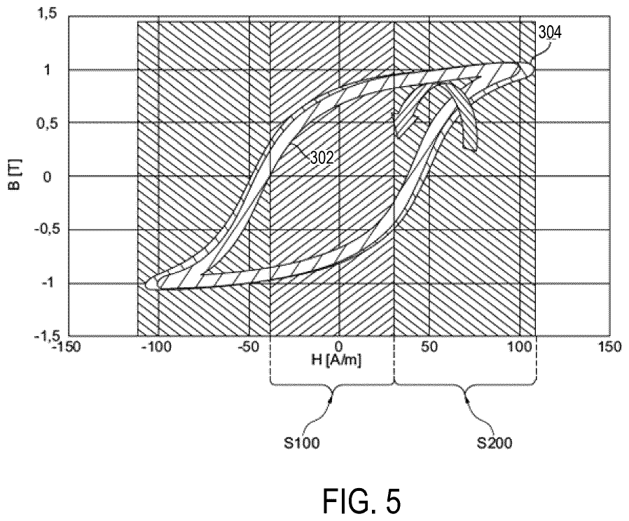

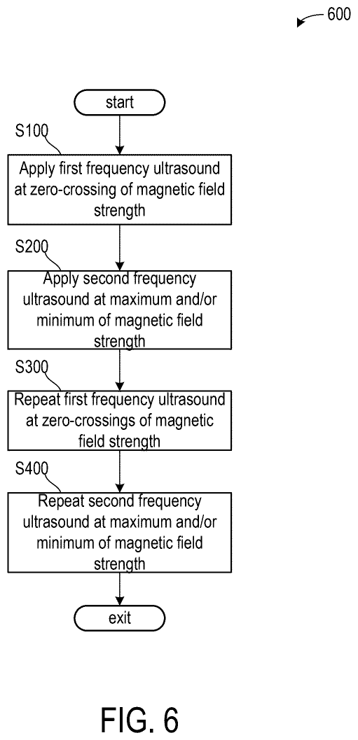

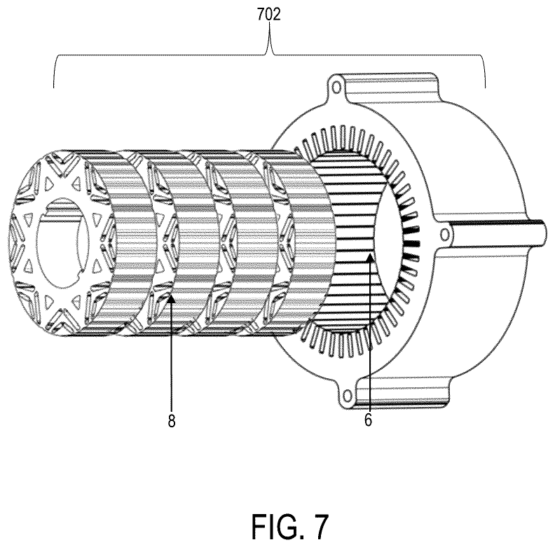

FIG. 1 shows a schematic exploded representation of an electric machine. FIG. 2 shows a schematic cross-sectional representation of a stator of the electric machine of FIG. 1. FIG. 3 shows a schematic representation of a comparison of two hysteresis curves. FIG. 4 shows a schematic representation of further details of the operation of the electric machine of FIG. 1. FIG. 5 shows a schematic representation of further details of the operation of the electric machine of FIG. 1. FIG. 6 shows a schematic representation of a process sequence for the operation of the electric machine of FIG. 1. FIG. 7 shows a second representation of the electric machine

Turning now to FIG. 1, it shows an example of an electric machine 4. The electric machine 4 is represented which, in the present exemplary embodiment, is employed as a traction motor in a motor vehicle 2.

In the present exemplary embodiment, the motor vehicle 2 is a motorized road vehicle such as, e.g. a passenger motor vehicle. By way of variation from the present exemplary embodiment, the motor vehicle 2 can also be embodied as a different type of motorized terrestrial vehicle such as, e.g. a rail-mounted vehicle, or as motorized watercraft, or as a motorized aircraft.

In the present exemplary embodiment, the electric machine 4 is configured to operate both in a motor mode, as a traction motor, and in a generator mode for the recovery of energy.

Additionally, or independently of operating modes, the electric machine 4 may be a direct current machine, an alternating current machine, or a three-phase alternating current machine.

Moreover, the electric machine 4, additionally or independently of operating modes and the configuration thereof as a direct current machine, an alternating current machine or a three-phase alternating current machine, can be configured with a permanently-excited, self-excited or externally-excited configuration.

By way of variation from the present exemplary embodiment, the electric machine 4 can also be configured as a non-rotating electrical machine 4, e.g. as a linear motor/generator, or as a transformer.

In the present exemplary embodiment, the electric machine 4 is configured as a rotating electrical machine 4 having a stator 6 and a rotor 8 such as, e.g. permanently-excited synchronous motor, or an asynchronous motor.

FIG. 7 shows an additional view of the stator 6 and the rotor 8, which constitute an electric steel core 702 of the electric machine 4.

In FIG. 1, it is further represented that the rotor 8 comprises a plate stack 10. The plate stack 10 forms part of a magnetic circuit and is comprised of a plurality of laminated electric sheet steel plates which, in the present exemplary embodiment, are comprised of iron having a silicon component of 3% to 4%. In analogous manner to the rotor 8, the stator 6 is comprised of laminated electric sheet steel plates, which also form a plate stack 18.

Particularly in the plate stack 18 of the stator 6, hysteresis losses occur in service, which are manifested in the form of thermal losses. Additionally, a phase displacement may occur between the magnetic flux and the electric current, although this is primarily attributable to inductance and reactance effects. The reason for this phase displacement is the work which it is necessary to apply for the magnetic reversal of the plate stack 18 of the stator 6 according to the rhythm of a working frequency of the electrical machine 4. Furthermore, the work demanded for the magnetic reversal of the plate stack 18 of the stator 6 in rhythm with the operating frequency of the electric machine 4 may lead to hysteresis losses. These losses also manifest as a phase displacement between the magnetic flux and the electric current, a phenomenon that occurs in addition to the phase displacements primarily caused by inductance and reactance. In the case e.g. of an asynchronous machine, the working frequency would be the frequency of the external rotating field which is generated by means of the stator.

A control system 90 is shown including a controller 92. The controller 92 is configured to receive feedback from a plurality of sensors 94. The controller 92 is further configured to send signals to a plurality of actuators 96 to adjust operation of the electric machine 4. The controller 92 may include memory, including non-transitory memory, with instructions stored thereon that cause the controller 92 to send signals to the plurality of actuators 96 based on feedback from the plurality of sensors 94.

Turning now to FIG. 2, it shows a cut-away view of the stator 6. In order to reduce hysteresis losses, the stator 6, which includes the stator core 12 and the stator housing 14, comprises a plurality of ultrasound emitters 16 which, in the present exemplary embodiment, are accommodated in locators of the stator housing 14 which are evenly spaced from one another in a circumferential direction. Via the ultrasound emitters 16, ultrasound can be applied to the stator core 12, and thus to the plate stack 18. In one example, the plurality of ultrasound emitters 16 are coupled to the controller 92 of FIG. 1. In one example, each of the ultrasound emitters is or includes a transducer configured to emit a high-frequency sound wave.

Additionally or alternatively, it can be provided that, in an analogous manner, ultrasound is applied to the plate stack 10 of the rotor 8. In one example, each of the plurality of ultrasound emitters 16 may be embedded in a location of the stator 6 between the stator core 12 and the stator housing 14.

Turning now to FIG. 3, it shows a plot illustrating various hysteresis curves. The x-axis illustrates a magnetic field strength (H) and the y-axis illustrates magnetic flux density shown in tesla (T). H may represent amperes per meter.

Via the application of ultrasound, via the ultrasound emitters, to the plate stack 18 of the stator 6, magnetic reversal losses of the plate stack 18 occurring in service can be reduced. This results in a modified hysteresis curve 302 which, in comparison with the preceding hysteresis curve 304, encloses a smaller area, which reduction is indicative of a reduced energy demand for magnetic reversal.

In this context, a magnetization or response of a soft magnet to an externally applied magnetic field results in a magnetic flux density (B) measured in tesla (T). It is intended that this polarization should remain consistent. This is critical to the torque of an electrical machine 4 which is operating in a motor mode. However, by the application of ultrasound, a polarization of equal magnitude may be achieved in the material via a magnetic field of a smaller magnitude.

In the example of FIG. 3, ultrasound at a frequency of 48 kHz (kilohertz) is applied. By way of variation from the present exemplary embodiment, ultrasound at a different frequency in the kHz or MHz (megahertz) range may also be employed. In some examples, different frequencies of ultrasound may be provided by at the same time or at disparate times. For example, one or more ultrasound emitters may provide ultrasound at a first frequency and one or more other ultrasound emitters may provide ultrasound at a second frequency, different than the first frequency. Additionally or alternatively, the plurality of ultrasound emitters may provide a first frequency of ultrasound at a first time and a second frequency of ultrasound at a second time, the second time following the first time and the second frequency different than the first frequency. In some examples, additionally or alternatively, the ultrasound frequency is based on a working frequency of the stator.

In the present exemplary embodiment, the working frequency is 100 Hz (hertz). That is, the plate stack 18 of the stator 6 undergoes magnetic reversal via an external rotating field at a frequency of 100 Hz. Thus, in the present exemplary embodiment, the ultrasound frequency which is applied to the plate stack by means of the ultrasound emitters 16 is 480 times the working frequency. Thus, during one cycle of the working frequency, 480 ultrasound pulses are applied to the plate stack 18 of the stator 6. By way of variation from the present exemplary embodiment, the frequency can also be 25 Hz, 50 Hz, 200 Hz, 400 Hz or 1 kHz, or can also assume a different value.

By way of variation from the present exemplary embodiment, the working frequency can also assume a different value. The working frequency is thus dependent upon the number of poles of the electrical machine 4, according to whether the electrical machine is configured with a two-pole or eight-pole or other number of poles configuration.

Moreover, by way of variation from the present exemplary embodiment, this ratio of frequency to the working frequency may also assume a different value. It is preferred that the frequency value is at least 20 times the working frequency.

Moreover, by the application of ultrasound to the plate stack 18 of the stator 6 of the electrical machine 4, the plate stack 18 of the stator 6 undergoes heat-up. Efficiency can thus be further increased, as a high temperature in the plate stack 18 of the stator 6 reduces eddy current losses.

Turning now to FIG. 4, it shows a current characteristic associated with the working frequency is represented. The x-axis represents angular frequency in radians and y-axis represents electric current in amperes. During a first step S100, ultrasound emitters 16 are actuated by the control device of the electrical machine 4 such that the ultrasound emitters 16 are deactivated, or are operated at a power which is lower than the target power or the maximum power.

Conversely, during a second step S200, ultrasound emitters 16 are actuated by a control device of the electrical machine 4 such that the ultrasound emitters 16 are operated at a target power or at a maximum power.

Thus, in the present exemplary embodiment, the first step S100 is executed in a region in which the current represented executes its zero-crossings, wherein the second step S200 is executed in a region in which the current represented achieves its maximum values or minimum values.

The duration of the first step S100, in relation to the period of oscillation or to the total duration of both steps S100 and S200, may be 5%, 10%, 20%, 30%, 40%, 50% or intermediate values thereof. The step S100 may be repeated at every zero-crossing, every other zero-crossing, every second zero-crossing, every third zero-crossing, and so on. The step S200 may be repeated at every maximum or minimum value, every other maximum or minimum value, every second maximum or minimum value, every third maximum or minimum value, and so on.

Turning now to FIG. 5, it shows regions represented by the two hysteresis curves 302 and 304 in which the two steps S100, S200 are executed.

FIG. 5 shows that the two hysteresis curves 302, 304, at high field strengths in the region of 100 A/m show a greater mutual distinction than in the event of low field strengths in the region below 25 A/m. Thus, ultrasound may not be activated at low field strengths, but only at high field strengths. In the event of an activation of ultrasound for field strengths in the region of 25A/m, the reductive effect on hysteresis curves is marginal whereas, at high field strengths (in a region in excess of 50 A/m, e.g. in the region of 100 A/m) this effect is substantially greater.

Turning now to FIG. 6, it shows a method 600 for operating the electrical machine including the ultrasound emitters. Instructions for carrying out method 600 may be executed by a controller based on instructions stored on a memory of the controller and in conjunction with signals received from sensors of the system, such as the sensors described above with reference to FIG. 1. The controller may employ actuators of the system to adjust operation, according to the method described below.

In a first step S100, at least intermittently, ultrasound is not applied by the ultrasound emitters 16, or is only applied to a reduced extent, to the plate stack 18 of the stator 6 of the electrical machine 4 during zero-crossings of the magnetic field strength, at the working frequency. In a second step S200, the application of ultrasound to the plate stack 18 of the stator 6 of the electrical machine 4 is executed in conjunction with maximum values and/or minimum values of the field strength of the electrical machine 4, which execution is applied e.g. to the plate stack 18 of a stationary part of the electrical machine 4, such as a stator 6 of a rotating electrical machine 4.

Ultrasound is employed at a frequency which is a multiple, in particular a 100× to 600× multiple, of the working frequency of the electrical machine 4.

In one example, it may be desired to apply ultrasound at higher operating frequencies of the electric machine, which may contribute to higher hysteresis losses. Higher operating frequencies may occur during high-speed applications and/or during a change in motor operation. High-speed applications may include vehicle speeds greater than a threshold vehicle speed and/or rotor speeds greater than or equal to a threshold rotor speed. The threshold vehicle speed and the threshold rotor speed are based on non-zero, positive numbers. Additionally, vehicle speed increases and decreases may increase hysteresis losses, and as such, ultrasound may be applied to speed increases and decreases. Additionally, or alternatively, it may be desired to apply the ultrasound when the electric machine temperature is less than a threshold temperature, wherein the threshold temperature is based on a non-zero, positive number. Since the ultrasound may heat the electric machine, it may be desired to apply the ultrasound when the electric machine is cooler. Additionally, or alternatively, ultrasound may be applied during higher torque events.

At a third step S300, the method 600 may include repeating the first frequency ultrasound at the zero-crossings of the magnetic field strength.

At the fourth step S400, the method 600 may include repeating the second frequency ultrasound at the maximums and/or the minimums of the magnetic field strength. In one example, the steps S300 and S400 alternate with one another such that two iterations of the step S100 may not occur without an iteration of the step S200 occurring therebetween. Similarly, two iterations of the step S200 may not occur without an iteration of the step S100 occurring therebetween.

In some examples, sequences of the steps S100 and the step S200 may be adjusted such that two or more iterations of one of the steps S100 or the step S200 occurs prior to executing an iteration of the other of the steps S100 or the step S200. Additionally or alternatively, a value of the frequency applied at the steps S100 and/or the step S200 may be increased or decreased during subsequent steps or during a current step.

Thus, by the application of ultrasound to the plate stack 18 of the stator 6 of the electrical machine 4, hysteresis losses are reduced, and overall energy efficiency is increased.

Moreover, by the application of ultrasound to the plate stack 18 of the stator 6 of the electrical machine 4, the plate stack 18 of the stator 6 undergoes heat-up. Efficiency may thus be further enhanced, as a high temperature in the plate stack 18 of the stator 6 reduces eddy current losses.

FIGS. 1-2 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

The disclosure also provides support for a method including applying an ultrasound to a plate stack of an electric machine during a first condition at a first frequency. In a first example of the method, the method further comprises: applying the ultrasound to the plate stack of the electric machine during a second condition at a second frequency, wherein the second condition is different than the first condition, and wherein the second frequency is different than the first frequency. In a second example of the method, optionally including the first example, the second condition is based on a zero-crossing of a magnetic field strength at a working frequency of the electric machine. In a third example of the method, optionally including one or both of the first and second examples, the first condition is based on a maximum value and/or a minimum value of a magnetic field strength within a working frequency of the electric machine. In a fourth example of the method, optionally including one or more or each of the first through third examples, the first frequency is based on a multiple of a working frequency of the electric machine. In a fifth example of the method, optionally including one or more or each of the first through fourth examples, the plate stack is arranged in a stationary portion of the electric machine. In a sixth example of the method, optionally including one or more or each of the first through fifth examples, the method further comprises: heating the plate stack via the ultrasound

The disclosure also provides support for a system including an electric machine comprising a stator and a rotor, at least one ultrasound emitter arranged in the stator, and a controller with computer-readable instructions stored in non-transitory memory thereof that when executed cause the controller to: activate the at least one ultrasound emitter to apply ultrasound to a plate stack of the rotor at a first frequency. In a first example of the system, the instructions further cause the controller to activate the at least one ultrasound emitter to apply ultrasound to the plate stack at a second frequency. In a second example of the system, optionally including the first example, the second frequency is less than the first frequency. In a third example of the system, optionally including one or both of the first and second examples, the first frequency is applied at a maximum value and/or a minimum value of a magnetic field strength within a working frequency of the electric machine, and wherein the second frequency is applied at a zero-crossing of the magnetic field strength at the working frequency of the electric machine. In a fourth example of the system, optionally including one or more or each of the first through third examples, the at least one ultrasound emitter is one of a plurality of ultrasound emitters. In a fifth example of the system, optionally including one or more or each of the first through fourth examples, the at least one ultrasound emitter is arranged between a stator housing and a stator core. In a sixth example of the system, optionally including one or more or each of the first through fifth examples, the instructions further cause the controller to deactivate the at least one ultrasound emitter. In a seventh example of the system, optionally including one or more or each of the first through sixth examples, a stator core is arranged between the at least one ultrasound emitter and the plate stack.

The disclosure also provides support for a system including an electric machine comprising a stator and a rotor, at least one ultrasound emitter arranged in the stator, and a controller with computer-readable instructions stored in non-transitory memory thereof that when executed cause the controller to: activate the at least one ultrasound emitter to apply ultrasound to a plate stack of the rotor at a first frequency at a first condition, and activate the at least one ultrasound emitter to apply ultrasound to the plate stack at a second frequency at a second condition. In a first example of the system, the instructions further cause the controller to deactivate the at least one ultrasound emitter during conditions outside of the first condition and the second condition. In a second example of the system, optionally including the first example, the second frequency is less than the first frequency. In a third example of the system, optionally including one or both of the first and second examples, the first frequency is based on a multiple of a working frequency of the electric machine, wherein the multiple is between 4 to 600. In a fourth example of the system, optionally including one or more or each of the first through third examples, the at least one ultrasound emitter is one of a plurality of ultrasound emitters equidistantly spaced along a circumference of a stator core of the stator.

Note that the example control and estimation routines included herein can be used with various vehicle system configurations. The control methods and routines disclosed herein may be stored as executable instructions in non-transitory memory and may be carried out by the control system including the controller in combination with the various sensors, actuators, and other hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the control system, where the described actions are carried out by executing the instructions in a system including the various hardware components in combination with the electronic controller.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
applying an ultrasound to a plate stack of an electric machine during a first condition at a first frequency.

2. The method of claim 1, further comprising applying the ultrasound to the plate stack of the electric machine during a second condition at a second frequency, wherein the second condition is different than the first condition, and wherein the second frequency is different than the first frequency.

3. The method of claim 2, wherein the second condition is based on a zero-crossing of a magnetic field strength at a working frequency of the electric machine.

4. The method of claim 1, wherein the first condition is based on a maximum value and/or a minimum value of a magnetic field strength within a working frequency of the electric machine.

5. The method of claim 1, wherein the first frequency is based on a multiple of a working frequency of the electric machine.

6. The method of claim 1, wherein the plate stack is arranged in a stationary portion of the electric machine.

7. The method of claim 1, further comprising heating the plate stack via the ultrasound.

8. A system, comprising:
an electric machine comprising a stator and a rotor;
at least one ultrasound emitter arranged in the stator; and
a controller with computer-readable instructions stored in non-transitory memory thereof that when executed cause the controller to:
activate the at least one ultrasound emitter to apply ultrasound to a plate stack of the rotor and the stator at a first frequency.

9. The system of claim 8, wherein the instructions further cause the controller to activate the at least one ultrasound emitter to apply ultrasound to the plate stack at a second frequency.

10. The system of claim 9, wherein the second frequency is less than the first frequency.

11. The system of claim 9, wherein the first frequency is applied at a maximum value and/or a minimum value of a magnetic field strength within a working frequency of the electric machine, and wherein the second frequency is applied at a zero-crossing of the magnetic field strength at the working frequency of the electric machine.

12. The system of claim 8, wherein the at least one ultrasound emitter is one of a plurality of ultrasound emitters.

13. The system of claim 8, wherein the at least one ultrasound emitter is arranged between a stator housing and a stator core.

14. The system of claim 8, wherein the instructions further cause the controller to deactivate the at least one ultrasound emitter.

15. The system of claim 8, wherein a stator core is arranged between the at least one ultrasound emitter and the plate stack.

16. A system, comprising:
an electric machine comprising a stator and a rotor;
at least one ultrasound emitter arranged in the stator; and
a controller with computer-readable instructions stored in non-transitory memory thereof that when executed cause the controller to:
activate the at least one ultrasound emitter to apply ultrasound to a plate stack of the rotor at a first frequency at a first condition; and
activate the at least one ultrasound emitter to apply ultrasound to the plate stack at a second frequency at a second condition.

17. The system of claim 16, wherein the instructions further cause the controller to deactivate the at least one ultrasound emitter during conditions outside of the first condition and the second condition.

18. The system of claim 16, wherein the second frequency is less than the first frequency.

19. The system of claim 16, wherein the first frequency is based on a multiple of a working frequency of the electric machine, wherein the multiple is between 4 to 600.

20. The system of claim 16, wherein the at least one ultrasound emitter is one of a plurality of ultrasound emitters equidistantly spaced along a circumference of a stator core of the stator.
